(19) United States
(12) Patent Application Publication
(10) Pub. No.: US 2022/0198267 A1
(43) Pub. Date: Jun. 23, 2022

(54) APPARATUS AND METHOD FOR ANOMALY DETECTION USING WEIGHTED AUTOENCODER

(71) Applicant: VMWARE, Inc., Palo Alto, CA (US)

(72) Inventors: Kiran Rama, Bangalore (IN); Stephen Harris, San Francisco, CA (US)

(21) Appl. No.: 17/176,206

(22) Filed: Feb. 16, 2021

(30) Foreign Application Priority Data
Dec. 18, 2020 (IN) 202041055258

(51) Int. Cl. G06N 3/08; G06K 9/62

(52) U.S. Cl. CPC G06N 3/08; G06K 9/6212; G06K 9/6232; G06K 9/6259

(57) ABSTRACT

Apparatus and method to detect anomalies in observations use a first plurality of observations regarding operation of a computing system, which are binned based on features values of the observations. Based on the binning, a weighting score is determined for the observations, which is applied to a loss function of an autoencoder. A second plurality of observations is then applied to the autoencoder as input to determine a reconstruction error value for each observation of the second plurality of observations. The reconstruction error values are used to detect anomalous observations of the second plurality of observations.

### RELATED APPLICATIONS

Benefit is claimed under 35 U.S.C. 119(a)-(d) to Foreign Application Serial No. 202041055258 filed in India entitled “APPARATUS AND METHO FOR ANOMALY DETECTION USING WEIGHTED AUTOENCODER”, on Dec. 18, 2020, by VMware, Inc., which is herein incorporated in its entirety by reference for all purposes.

### BACKGROUND

Anomalous data points in a stream or batch of data points are identified and used to better understand the data. Anomaly detection involves building a profile of normal behavior and using the normal profile to detect outliers. The anomalous data points are considerably different from the remainder of the data. In predictive data mining, outliers are sometimes removed or treated as part of data preprocessing. The normal data is then used for prediction, evaluation, or heuristics. Anomaly detection differs from normal data mining in the sense that the outliers are the point of interest, while in data mining, the outliers are normally removed. Depending on the nature of the data, anomalous data points may be used to understand system failure or stress modes, to discover new service or market opportunities, and to detect threats or intrusions into a system.

Anomaly detection requires significant computation resources in many applications, especially when there is a large data set with many different features to evaluate. Some methods for anomaly detection are based on deviance from assumed distributions or on proximity using partitioning methods, based on distance, density, clustering etc. Non-parametric methods include the construction of univariate histograms per feature into a number of bins and replacing each value in the feature with its relative frequency. The product of the inverse of the features in each observation is used to arrive at an anomaly score. Reconstruction methods have been used to build a profile of the normal behavior using a dimensionality reduction technique or using a deep learning technique such as an autoencoder. An autoencoder learns a compressed representation of the input at a bottleneck layer. In reconstruction methods, the anomalous observations are those that have the highest reconstruction error. In autoencoder methods, the anomalous observations typically do not fit into the compressed representation at the bottleneck layers.

### SUMMARY

Apparatus and method to detect anomalies in observations use a first plurality of observations regarding operation of a computing system, which are binned based on features values of the observations. Based on the binning, a weighting score is determined for the observations, which is applied to a loss function of an autoencoder. A second plurality of observations is then applied to the autoencoder as input to determine a reconstruction error value for each observation of the second plurality of observations. The reconstruction error values are used to detect anomalous observations of the second plurality of observations.

A computer-implemented method to detect anomalies in observations in accordance with an embodiment includes receiving a first plurality of observations regarding operation of a computing system, the observations each having a feature value, binning the observations based on the respective feature values, determining a weighting score for the observations based on the binning, applying the weighting score to a loss function of an autoencoder, receiving a second plurality of observations, applying the second plurality of observations as input to the autoencoder to determine a reconstruction error value for each observation of the second plurality of observations, and detecting a subset of the second plurality of observations as anomalous using the respective reconstruction error values. In some embodiments, the steps of this method are performed when instructions in a computer-readable storage medium are executed by a computer.

An apparatus to detect anomalies in observations in accordance with an embodiment of the invention includes a non-transitory memory comprising executable instructions, and a processor coupled to the memory and configured to execute the instructions to cause the apparatus to perform operations of receiving a first plurality of observations regarding operation of a computing system, the observations each having a feature value, binning the observations based on the respective feature values, determining a weighting score for the observations based on the binning, applying the weighting score to a loss function of an autoencoder, receiving a second plurality of observations, applying the second plurality of observations as input to the autoencoder to determine a reconstruction error value for each observation of the second plurality of observations, and detecting a subset of the second plurality of observations as anomalous using the respective reconstruction error values.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a system overview diagram of a deep learning and anomaly detection process in accordance with an embodiment of the invention.

FIG. 2 is a diagram of an example of a histogram binning heuristic that may be applied to input training observations in accordance with an embodiment of the invention.

FIG. 3 is a diagram of an example of an interval width binning heuristic that may be applied to input training observations in accordance with an embodiment of the invention.

FIG. 4 is a process flow diagram of determining a weighting score using a binning method in accordance with an embodiment of the invention.

FIG. 5 is a diagram of an autoencoder with a weighted loss function in accordance with an embodiment of the invention.

FIG. 6 is a process flow diagram of anomaly detection in accordance with an embodiment of the invention.

FIG. 7 is a block diagram of a hybrid cloud system suitable for implementing aspect of embodiments of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

The autoencoder approach to a deep learning system provides high predictive accuracy at reasonable computational cost, but can be improved by weighting the reconstruction error of the autoencoder. In some embodiments, a higher penalty is associated with incorrect predictions of normal observations. The weighted reconstruction error increases the boundary between normal and anomalous observations so that anomalous data points are easier to detect. The higher penalty may be generated from an anomaly detection heuristic derived from a non-parametric statistical method. An autoencoder based reconstruction method detects anomalous observations as those that have a high reconstruction error. The detection is improved using a heuristic from another method to weight the reconstruction error of anomalous observations still higher. The weighting with a prior heuristic penalizes the reconstruction error of the anomalous observations, further increasing the separation between anomalous and normal instances. While embodiments are described in the context of batch operations, embodiments are also applicable to streaming operations.

Embodiments herein may pertain to supervised data sets, unsupervised data sets, and semi-supervised data sets. With supervised data sets, there are labels provided for both normal and anomalous observations. These data sets tend to be imbalanced. Supervised datasets are the easiest to handle and there is a plethora of data mining techniques in literature to handle them. More frequent use cases pertain to learning with semi-supervised and unsupervised data sets. In unsupervised problems, there are absolutely no labels. In semi-supervised problems, there are labels provided only for a few of the normal observations and a few of the outlier anomalous observations, sometimes only for a single class of observations. In the real world, most of the datasets are unlabeled or insufficiently labeled and usually, labels are only from ‘discovered’ anomalies forming semi-supervised learning problems. Additional labeling is a ‘costly’ exercise in terms of resources and time.

As described below, weighting the observations of an autoencoder with the anomaly scores from a non-parametric statistical heuristic can increase the separation boundary between the reconstructed anomalous and normal observations. Statistical non-parametric heuristics are described that assign a higher weight to observations with features that have values in dense regions of a binning process. Observations are binned using histograms or interval widths. The normal observations will have more values in the dense regions as represented by the density of the bins in the histogram cases or the lower interval width in fixed interval bins.

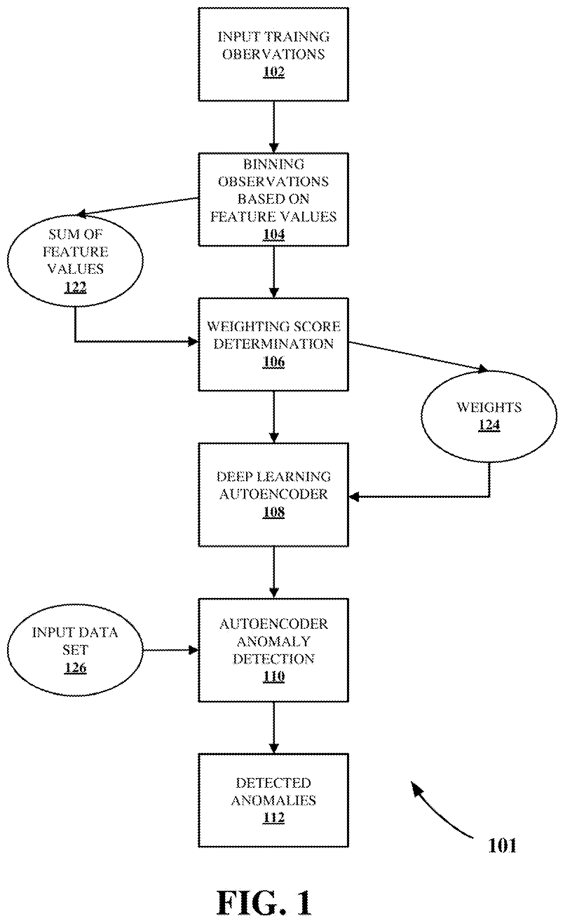

Turning to FIG. 1, a system overview diagram of the deep learning and anomaly detection process 101 has three major parts: binning, weighting, and training. First, input training observations 102 are binned 104 based on feature values of the observations. In some embodiments, there are semi-supervised or unsupervised input training observations. The binning provides feature value sums 122 for the various bins. The nature and organization of the sums may vary based on the specific details of the binning 104. The sums are applied to determine weighting scores 106. In some embodiments, the weighting scores are in the form of a matrix of weights 124. The weights are applied to a deep learning autoencoder 108. Thus, the autoencoder is training on the input training observations 102 using the weights 124, which is further described in more detail below.

Once the autoencoder is trained 108, an input set of observations 126 that may or may not include anomalous observations is applied to the autoencoder for anomaly detection 110. This results in anomalies being detected 112 if there are any anomalies in the input set of observations 126. Additional sets of observations may be applied and some or all of these observations may be used as input training observations 102 for additional training.

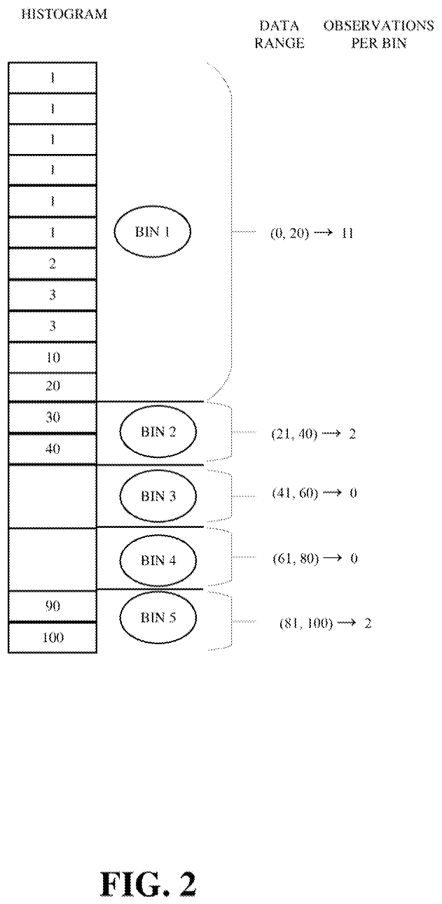

FIG. 2 is a diagram of one example of a histogram binning heuristic that may be applied to the input training observations in order to determine weights for the autoencoder. Two types of binning heuristics are described herein, but others may alternatively be used to suit particular implementations. The first is referred to herein as a histogram method and the second is referred to as a fixed interval binning method. Both these methods present an anomaly heuristic that has a higher value for normal observations. The original feature values are replaced with values from the bins for purposes of a weight feature calculation. The autoencoder operates using the actual feature values as input but subject to the weights.

In the example of FIG. 2, a histogram has five bins, labeled 1, 2, 3, 4, and 5. There are 15 observations each with a feature value. The feature values range from 1 to 100. Each bin has a data range of 20. Accordingly, bin 5 has a data range of 81-100 and there are two observations in the bin, one having a feature value of 90 and the other having a feature value of 100. Bin 4 has a data range of 61-80 and bin 3 has a data range of 41-60. There are no observations with feature values in either of those ranges. Bin 2 has two observations and bin 1 has 11 observations. The histogram indicates that the observations with feature values of 90 to 100 are anomalous but it is not obvious whether the observations in bin 2 or even the two observations with the highest feature values in bin 1 should be classified as anomalous. The number of bins, the data range, the number of observations, and the feature values of observations are provided as examples only. Different input data sets may provide different feature values and may be better suited to more or fewer bins with larger or smaller data ranges.

For the histogram binning, each feature is divided into k equal bins. If n is the total number of observations and b is the total number of bins, then the histogram function m(i) meets the condition in Equation (1) below. The number of bins may be chosen based on the nature of the data and the variations in feature values. In some implementations 10 bins are used. In some implementations \sqrt{n} bins are used. The values of the feature are replaced with the normalized bin counts of the histogram. Intuitively, it is clear that in the case of the histogram method, the feature values replaced with the normalized bin counts have higher values for the normal observations (as their features have high-density regions) and lower values for the anomalous observations (as these have values in low-density regions

$$n = {\sum }_{i = 1}^{b} m ( i ) \qquad ( 1 )$$

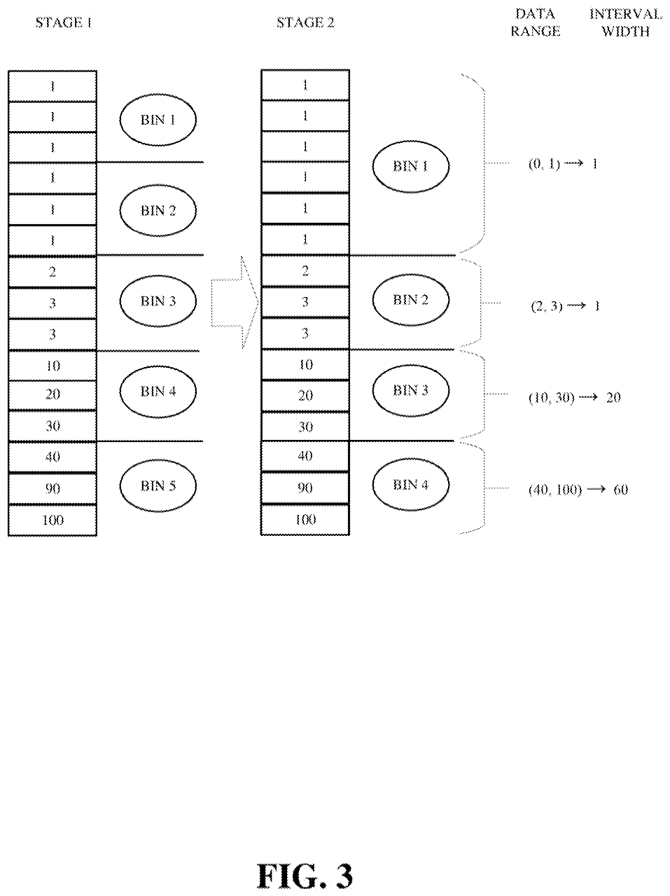

FIG. 3 is a diagram of one example of an interval width binning heuristic that may be applied to the input training observations in order to determine weights for the autoencoder. The feature values of each observation are grouped into bins such that there are not overlapping intervals between the bins. The feature values of the observations are first sorted in ascending order and divided into buckets, i.e., bins, such that each bin has an equal number of observations. This is shown as Stage 1 in which each bin has three observations with the smallest feature value at the top. Let featureⁱₛₜₐᵣₜ and featureⁱ_{end} denote the starting and ending values of each of the i groups. All overlapping intervals with the same value are merged into the same interval as shown in Stage 2. This is also represented by Equation (2) below, where b denotes the number of bins.

∀_{k∈b} if feature_{end}^{k}=featureₛₜₐᵣₜ^{k+1}, merge the bins into fewer bins (2)

In this example interval width method, the feature values are replaced with the inverse of the width of the intervals. The inverse width is then normalized using min-max scaling, i.e., dividing by the maximum inverse width value. Intuitively, it is clear that for normal observations, the interval width is likely to be small. For example, in FIG. 3, bins 1 and 2 have an interval width of 1. For anomalous observations, the interval width is likely to be large. For example, in FIG. 3, bins 3 and 4 have interval widths of 20 and 60, respectively. The inverse of the sum of the normalized interval widths for the variables may be taken as the anomaly heuristic. This will be larger for normal observations and smaller for anomalous observations.

The weighting score may be determined using the results from the binning operations using the idea that high-density features have a higher value of the normalized bin counts. The weighting score serves as a heuristic in the autoencoder stage to weight observations of the autoencoder. The weighting score acts as a penalization for the reconstruction of the anomalous examples. The observations with a higher reconstruction error are considered anomalous in the autoencoder method. The weighting scores are configured to weight the observations such that anomalous observations become more difficult to reconstruct, making the reconstruction error still higher.

For the histogram binning, the bin counts are higher for the normal observations, for example 11, compared to 0 or 2. These bin counts may be normalized, depending on the operation of the autoencoder. In some embodiments, the total number of observations is used to normalize the bin counts yielding a weighting score of 0.73, 0.13, 0, 0, and 0.13, the normalized bin counts for all 15 observations.

For the interval width binning, the weighting score may be defined as the inverse of the normalized interval width for each bin of feature values. Both the histogram and interval width methods are heuristic measures that have a higher value for observations with features in dense areas. In the fixed interval binning heuristic in FIG. 3, the interval widths are 1, 1, 20, 60. The normalized interval widths are 0.01 (feature interval width of 1 divided by the full range of the feature in this case 100), 0.01, 0.2, and 0.6. The inverse normalized interval widths are 100, 100, 5, and 1.6. This is a univariate measure that is non-parametric.

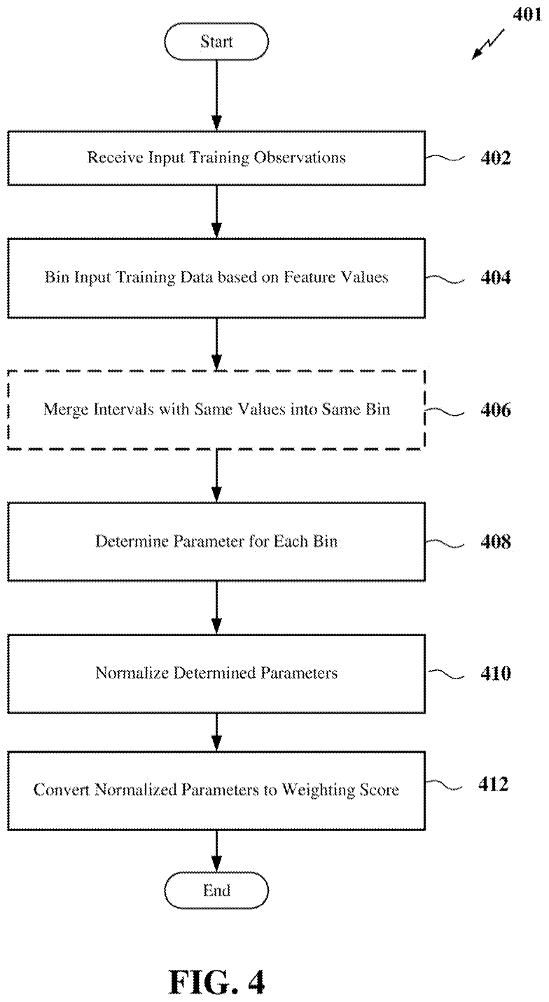

FIG. 4 is a process flow diagram 401 for determining a weighting score using a binning method as shown and described in FIGS. 2 and 3. At step 402, input training observations are received. These may be the same as the input data for anomaly detection or different depending on the implementation. At step 404, the input training data is binned. Any of a variety of binning methodologies may be used including histogram and variable interval width as described herein. At step 406, bins may optionally be merged to suit the particular binning methodology. In the example of FIG. 3, Stage 2 intervals that have overlapping or the same values may be merged into a single bin. As shown in Stage 2, not all bins have the same number of observations after the bins are merged from those of Stage 1.

At step 408, a parameter is determined for each bin, such as a number of observations as in FIG. 2 or an interval width as in FIG. 3. The determined parameter is normalized at step 410, and then, at step 412, the normalized parameters are converted into a suitable format for a weighting score. In some embodiments, the format is a one-dimensional weight matrix suitable for use by a weight loss function of an autoencoder.

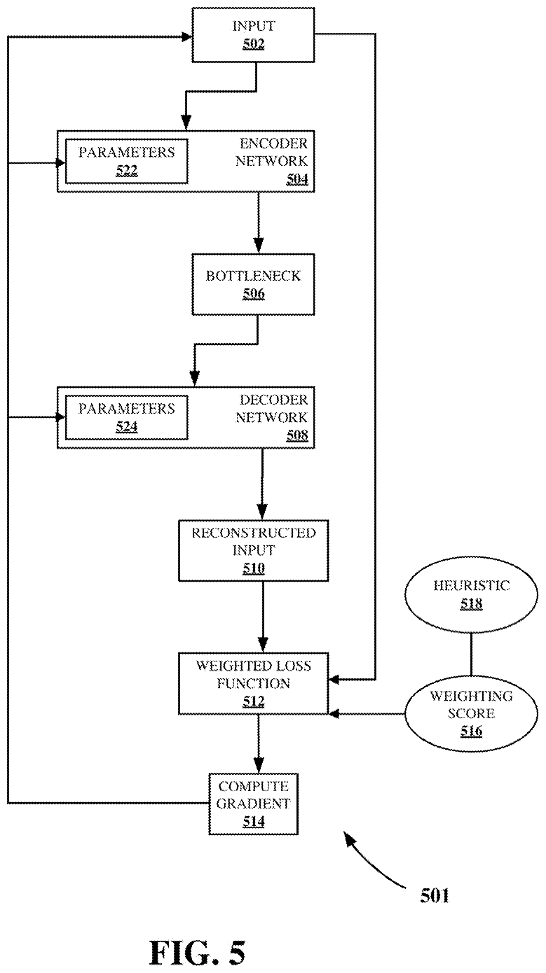

FIG. 5 is a diagram of an example autoencoder 501 suitable for use with the training and processing described herein. The weighting score 516 that is developed from the heuristics 518 as described above is applied to a weighted loss function 512 of an autoencoder to aid in anomaly detection by the encoder as applied to input data 502. The input data 502 at first is a training data set of input observations that may or may not be supervised or semi-supervised. The input data 502 is applied as training data to an encoder network 504. The resulting encoded observations are applied to a bottleneck layer 506 to reduce the information in the encoded data. The bottleneck output is applied to a decoder network 508 that attempts to recover the original input data 502 by reconstruction. The decoder network produces reconstructed input 510 that is applied to a weighted loss function 512. The loss function is weighted by the weighting score 516. A gradient 514 is computed from the weighted loss function and the computed gradient 514 is used to update parameters 522 in the encoder network 504 and parameters 524 in the decoder network 508. As the autoencoder converges on stable values, it has been trained. The same structure is then used for new input data after training to detect anomalies in the observations of the input data 502 based on the reconstruction error score as determined in the compute gradient. The anomalous observations are identified as anomalous by the autoencoder based on the reconstruction error value. The system may apply a threshold such that observations with a reconstruction error value above the threshold are identified as anomalous observations. In other embodiments, no threshold is required.

The autoencoder is modified in FIG. 5 in that the loss function 512 is weighted using the binning heuristic, either a histogram binning or an interval width binning or another type of binning. The binning is used to generate the weighting score which may be provided in any suitable way such as a matrix. Generically, the matrix may be designated generically as B which is a n*1 matrix with n rows and 1 column. The input data 502 may be denoted by X which is a n*m matrix with n rows and m columns. Each successive layer I in the encoder network 504 applies a non-linear activation function, for example, ReLU on top of, for example, an affine transformation such as that defined in Equation (3), where i is the i^{th} layer of the autoencoder and W⁽ⁱ⁾ is the weight matrix for layer i in the network. If there are hᵢ hidden nodes in the i^{th} layer, the dimensionality of E₍ᵢ₎ reads hᵢ₋₁*hᵢ. For example, the first hidden layer weights would have dimensionality m*h₁. The decoder network forms are the mirror images of the encoder network forms, as shown in equation (4). Accordingly, the dimensionality of the first decoder layer is the opposite of the last encoder layer.

E₍ᵢ₎=ReLU(X.W_{E}⁽ⁱ⁾) (3)

D₍ᵢ₎=ReLU(E₍ᵢ₎.W_{D}⁽ⁱ⁾) (4)

ReLU is a non-linear activation function with the form ReLU(x)=0 if x<0 and x if x>=0. The sigmoid and tanh activation functions have been widely used and may be used as alternatives to the ReLU function. Other alternatives may also be used. ReLU may be preferred for deep learning for its simplicity of computation. Calculating the gradient is simpler than calculating sigmoid and tangent functions. ReLU has also been shown to be more powerful for training in many uses.

There is one hidden layer each, in the encoder network 504, bottleneck layer 506, and decoder network 508 functions of the example autoencoder 501. The output of the encoder network and the decoder network may be indicated mathematically as shown in Equation (5) and Equation (6). Note that W₁ and W₂ are the weight matrices associated with the encoder network 504 and bottleneck layer 506 and the weight matrix W₃ is associated with the decoder network 508.

encode(X)=ReLU(ReLU(X.W₁).W₂) (5)

decode(X)=ReLU(encode(X).W₃) (6)

The weighted loss function 512 may be the weighted Euclidean distance between the reconstructed input and the output. The loss function is described in Equation (7) and, as indicated, the Euclidean distance is weighted by the bin weights matrix B which is a n*1 matrix where n is the number of observations. This matrix is the histogram bin weighted matrix or the interval width bin weighted matrix. The loss values that are so generated are referred to as the reconstruction errors. A higher reconstruction error means that the input observation was challenging to reconstruct because it is not similar to the rest of the observations and is likely to be an anomalous observation. The observations with the highest value of the reconstruction error as given by Equation (7) are the anomalies or outliers. Note that Equation (7) includes a multiplication by the weight matrix B that makes the loss a weighted loss.

loss=B*(decode(encode(X))−X)² (7)

In many applications, the loss function B results in increasing the boundary between normal and anomalous observations. In some embodiments, both binning methodologies, histogram and fixed interval, are used to generate two different weighted loss matrices B. The autoencoder is tested with both weighted loss matrices and the best performing matrix B is chosen for the solution.

The described methodology uses the anomaly scores from non-parametric statistical methods as weights into a weighted loss function of an autoencoder. The combination of these two concepts into a novel architecture has a sound mathematical foundation and is able to outperform existing methods with greater accuracy. The weighted autoencoder as described herein outperforms the existing anomaly detection techniques. The mathematical reasoning and intuition as to why it works is provided above.

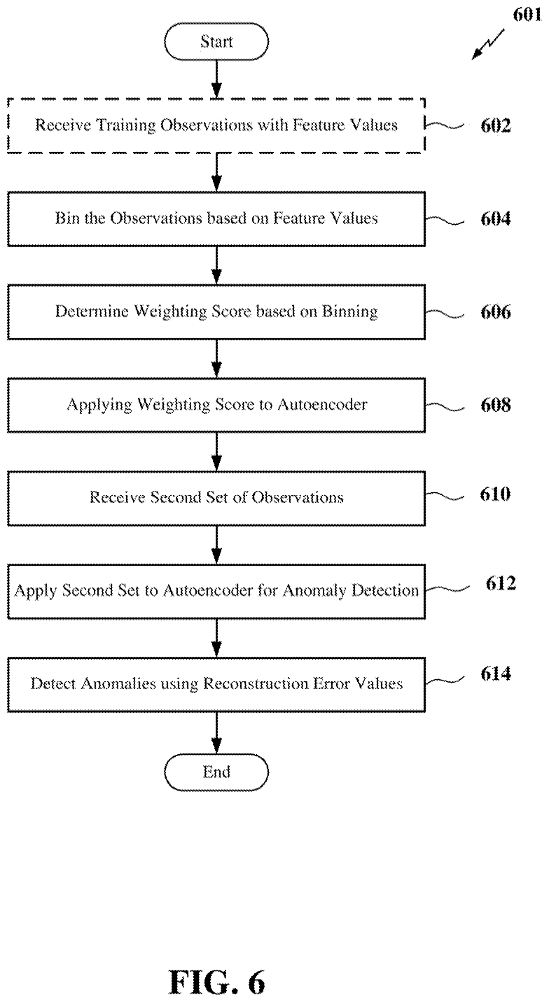

FIG. 6 is a process flow diagram 601 of anomaly detection for an input set as described herein. The described process is useful for detecting anomalies in a wide range of different sets of observations that have values for one or more features. The process begins at step 602 with optionally receiving training observations that include feature values for the observations. This may be batch data or streaming data. A suitable set of training observations may be labeled, partially labeled, or not labeled. This operation is optional in that actual input data may alternatively be used. These observations may be an actual input data set for anomaly detection or a specific set of training observations. At 604, the training observations are binned using one or more of the described methodologies or another methodology as described above.

In a histogram binning, each observation is placed in a respective bin. Each bin has a same interval of feature values. A weighting score is determined by determining a sum of the number of observations in each bin and normalizing the sums such that observations with feature values in a bin with a higher sum have a lower weight. Normalizing may be done by dividing each sum by the highest sum or in another way. In an interval width binning bins are generated with different intervals of feature values such that each bin has an equal number of observations. The interval of each bin is normalized and an inverse of the normalized interval of each bin is determined such that observations with feature values in a bin with a smaller interval have a lower weight. The normalizing may be done by dividing each interval by the largest interval or in another way.

At step 606, the binning is used to determine a weighting score. In some embodiments, the weighting score is in the form of a matrix having a score for each observation derived from the binning of the feature values. The weighting score is configured to increase the reconstruction error value for observations having incorrect reconstruction in the autoencoder, thereby acting as a penalizer. In the above examples, normalized representations of the bin interval width or bin population are used. Other approaches may be used to determine the weighting score for the same or different binning methodologies. The autoencoder is then trained using the weighted loss function and parameters of the encoder network and decoder network are updated through multiple network layers.

At step 608, the weighting score is applied to the autoencoder at a loss function. At step 610, the same or a new data set is received as the second set of observations. This may also be batch data or streaming data. At step 612, the second set of observations are applied to the trained autoencoder for anomaly detection. At step 614, the anomalies are detected using reconstruction error values at the weighted loss function. In some embodiments, the reconstruction error value for each input feature value is derived from the weighted loss function of the autoencoder. In some embodiments, the weighted loss function is a weighted Euclidean distance between an input observation and a reconstructed output of the autoencoder. The weights coming from the binning methods penalize the reconstruction of anomalous observations, making the weighted autoencoder more effective in capturing anomalous observations.

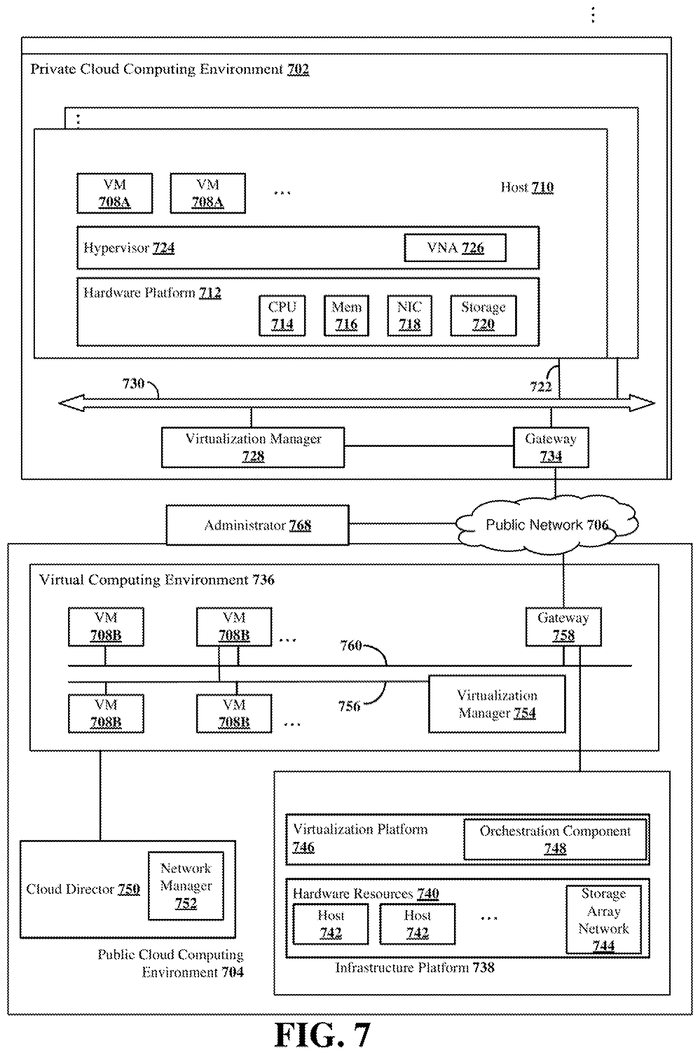

Turning now to FIG. 7, a block diagram of a hybrid cloud system suitable for implementing embodiments of the invention. Such a system provides many different nodes for taking observations of the operation of the system and for operating the autoencoder described herein to detect anomalies in those observations. Alternatively, the observations may be imported from another system for anomaly detection on the described hybrid cloud system. Alternatively, the methods described herein may be performed by an administrator or a much simpler isolated system with or without virtualization. The hybrid cloud system includes at least one private cloud computing environment 702 and at least one public cloud computing environment 704 that are connected via a public network 706, such as the Internet. The hybrid cloud system is configured to provide a common platform for managing and executing workloads seamlessly between the private and public cloud computing environments. In one embodiment, the private cloud computing environment may be controlled and administered by a particular enterprise or business organization, while the public cloud computing environment may be operated by a cloud computing service provider and exposed as a service available to account holders or tenants, such as the particular enterprise in addition to other enterprises.

In some embodiments, the private cloud computing environment may comprise one or more on-premises data centers. The public cloud computing environment 704 provides a virtual private cloud to augment the private cloud computing environment 702. The connections may be made through virtual private networks or other cross-connection tunnels, including virtual interfaces.

The private and public cloud computing environments 702 and 704 of the hybrid cloud system include computing and/or storage infrastructures to support a number of virtual computing instances, VMs 708A and 708B. As used herein, the term “virtual computing instance” refers to any software entity that can run on a computer system, such as a software application, a software process, a virtual machine (VM), e.g., a VM supported by virtualization products of VMware, Inc., and a software “container”, e.g., a Docker container. However, in this disclosure, the virtual computing instances will be described as being VMs, although embodiments of the invention described herein are not limited to VMs.

The VMs 708A and 708B running in the private and public cloud computing environments 702 and 704, respectively, may be used to form virtual data centers using resources from both the private and public cloud computing environments. The VMs within a virtual data center can use private IP (Internet Protocol) addresses to communicate with each other since these communications are within the same virtual data center. However, in conventional cloud systems, VMs in different virtual data centers require at least one public IP address to communicate with external devices, i.e., devices external to the virtual data centers, via the public network. Thus, each virtual data center would typically need at least one public IP address for such communications.

As shown in FIG. 7, the private cloud computing environment 702 of the hybrid cloud system includes one or more host computer systems (“hosts”) 710. The hosts may be constructed on a server grade hardware platform 712, such as an x86 architecture platform. As shown, the hardware platform of each host may include conventional components of a computing device, such as one or more processors (e.g., CPUs) 714, system memory 716, a network interface 718, storage system 720, and other I/O devices such as, for example, a mouse and a keyboard (not shown). The processor 714 is configured to execute instructions, for example, executable instructions that perform one or more operations described herein and may be stored in the memory 716 and the storage system 720. The memory 716 is volatile memory used for retrieving programs and processing data. The memory 716 may include, for example, one or more random access memory (RAM) modules. The network interface 718 enables the host 710 to communicate with another device via a communication medium, such as a physical network 722 within the private cloud computing environment 702.

The physical network 722 may include physical hubs, physical switches and/or physical routers that interconnect the hosts 710 and other components in the private cloud computing environment 702. The network interface 718 may be one or more network adapters, such as a Network Interface Card (NIC). The storage system 720 represents local storage devices (e.g., one or more hard disks, flash memory modules, solid state disks and optical disks) and/or a storage interface that enables the host 710 to communicate with one or more network data storage systems. An example of a storage interface is a host bus adapter (HBA) that couples the host 710 to one or more storage arrays, such as a storage area network (SAN) or a network-attached storage (NAS), as well as other network data storage systems. The storage system 720 is used to store information, such as executable instructions, cryptographic keys, virtual disks, configurations, and other data, which can be retrieved by the host 710.

Each host 710 may be configured to provide a virtualization layer that abstracts processor, memory, storage, and networking resources of the hardware platform 712 into the virtual computing instances, e.g., the VMs 708A, that run concurrently on the same host. The VMs run on top of a software interface layer, which is referred to herein as a hypervisor 724, that enables sharing of the hardware resources of the host by the VMs. One example of the hypervisor 724 that may be used in an embodiment described herein is a VMware ESXi™ hypervisor provided as part of the VMware vSphere® solution made commercially available from VMware, Inc. The hypervisor 724 may run on top of the operating system of the host or directly on hardware components of the host. For other types of virtual computing instances, the host 710 may include other virtualization software platforms to support those processing entities, such as the Docker virtualization platform to support software containers.

In the illustrated embodiment, the host 710 also includes a virtual network agent 726. The virtual network agent 726 operates with the hypervisor 724 to provide virtual networking capabilities, such as bridging, L3 routing, L2 Switching and firewall capabilities, so that software-defined networks or virtual networks can be created. The virtual network agent 726 may be part of a VMware NSX® virtual network product installed in the host 710. In a particular implementation, the virtual network agent 726 may be a virtual extensible local area network (VXLAN) endpoint device (VTEP) that operates to execute operations with respect to encapsulation and decapsulation of packets to support a VXLAN backed overlay network.

The private cloud computing environment 702 includes a virtualization manager 728 that communicates with the hosts 710 via a management network 730. In an embodiment, the virtualization manager 728 is a computer program that resides and executes in a computer system, such as one of the hosts 710, or in a virtual computing instance, such as one of the VMs 708A running on the hosts. One example of the virtualization manager 728 is the VMware vCenter Server® product made available from VMware, Inc. The virtualization manager 728 is configured to carry out administrative tasks for the private cloud computing environment 702, including managing the hosts 710, managing the VMs 708A running within each host, provisioning new VMs, migrating the VMs from one host to another host, and load balancing between the hosts.

The virtualization manager 728 is configured to control network traffic into the public network 706 via a private cloud gateway device 734, which may be implemented as a virtual appliance. The gateway device 734 is configured to provide the VMs 708A and other devices in the private cloud computing environment 702 with connectivity to external devices via the public network 706. The gateway device 734 serves as a perimeter edge router for the on-premises or co-located computing environment 702 and stores routing tables, network interface layer or link layer information and policies, such as IP security policies, for routing traffic between the on-premises and one or more remote computing environments.

The public cloud computing environment 704 of the hybrid cloud system is configured to dynamically provide enterprises (referred to herein as “tenants”) with one or more virtual computing environments 736 in which administrators of the tenants may provision virtual computing instances, e.g., the VMs 708B, and install and execute various applications. The public cloud computing environment 704 includes an infrastructure platform 738 upon which the virtual computing environments 736 can be executed. In the particular embodiment of FIG. 7, the infrastructure platform 738 includes hardware resources 740 having computing resources (e.g., hosts 742), storage resources (e.g., one or more storage array systems, such as a storage area network (SAN) 744), and networking resources (not illustrated), and a virtualization platform 746, which is programmed and/or configured to provide the virtual computing environments 736 that support the VMs 708B across the hosts 742. The virtualization platform 746 may be implemented using one or more software programs that reside and execute in one or more computer systems, such as the hosts 742, or in one or more virtual computing instances, such as the VMs 708B, running on the hosts 742.

In one embodiment, the virtualization platform 746 includes an orchestration component 748 that provides infrastructure resources to the virtual computing environments 736 responsive to provisioning requests. The orchestration component may instantiate VMs according to a requested template that defines one or more VMs having specified virtual computing resources (e.g., compute, networking, and storage resources). Further, the orchestration component may monitor the infrastructure resource consumption levels and requirements of the virtual computing environments and provide additional infrastructure resources to the virtual computing environments as needed or desired. In one example, similar to the private cloud computing environment 702, the virtualization platform may be implemented by running on the hosts 742 VMware ESXI®-based hypervisor technologies provided by VMware, Inc. However, the virtualization platform may be implemented using any other virtualization technologies, including Xen®, Microsoft Hyper-V® and/or Docker virtualization technologies, depending on the processing entities being used in the public cloud computing environment 704.

In one embodiment, the public cloud computing environment 704 may include a cloud director 750 that manages allocation of virtual computing resources to different tenants. The cloud director 750 may be accessible to users via a REST (Representational State Transfer) API (Application Programming Interface) or any other client-server communication protocol. The cloud director 750 may authenticate connection attempts from the tenants using credentials issued by the cloud computing provider. The cloud director receives provisioning requests submitted (e.g., via REST API calls) and may propagate such requests to the orchestration component 748 to instantiate the requested VMs (e.g., the VMs 708B). One example of the cloud director 750 is the VMware vCloud Director® product from VMware, Inc.

In one embodiment, the cloud director 750 may include a network manager 752, which operates to manage and control virtual networks in the public cloud computing environment 704 and/or the private cloud computing environment 702. Virtual networks, also referred to as logical overlay networks, comprise logical network devices and connections that are then mapped to physical networking resources, such as physical network components, e.g., physical switches, physical hubs, and physical routers, in a manner analogous to the manner in which other physical resources, such as compute and storage, are virtualized. In an embodiment, the network manager 752 has access to information regarding the physical network components in the public cloud computing environment 704 and/or the private cloud computing environment 702. With the physical network information, the network manager 752 may map the logical network configurations, e.g., logical switches, routers, and security devices to the physical network components that convey, route, and filter physical traffic in in the public cloud computing environment 704 and/or the private cloud computing environment 702. In one implementation, the network manager 752 is a VMware NSX® manager running on a physical computer, such as one of the hosts 742, or a virtual computing instance running on one of the hosts.

In one embodiment, at least some of the virtual computing environments 736 may be configured as virtual data centers. Each virtual computing environment includes one or more virtual computing instances, such as the VMs 708B, and one or more virtualization managers 754. The virtualization managers 754 may be similar to the virtualization manager 728 in the private cloud computing environment 702. One example of the virtualization manager 754 is the VMware vCenter Server® product made available from VMware, Inc. Each virtual computing environment may further include one or more virtual networks 756 used to communicate between the VMs 708B running in that environment and managed by at least one public cloud networking gateway device 758 as well as one or more isolated internal networks 760 not connected to the public cloud gateway device 758. The gateway device 758, which may be a virtual appliance, is configured to provide the VMs 708B and other components in the virtual computing environment 736 with connectivity to external devices, such as components in the private cloud computing environment 702 via the public network 706.

The public cloud gateway device 758 operates in a similar manner to the private cloud gateway device 734 in the private cloud computing environment. The public cloud gateway device 758 operates as a remote perimeter edge router for the public cloud computing environment and stores routing tables, network interface layer or link layer information and policies such as IP security policies for routing traffic between the on-premises and one or more remote computing environments.

An administrator 768 is coupled to both of the edge routers 734, 758 and any other routers on the edge of either network through the public network 706 and is able to collect publicly exposed connection information such as routing configurations, routing tables, network interface layer information, local link layer information, policies, etc. The administrator is able to use this information to build a network topology for use in troubleshooting, visibility, and administrative tasks. In some hybrid cloud scenarios, the information about vendor-specific communication mechanism constructs is not necessarily available via the public APIs that are exposed by cloud vendors. As described herein, the administrator is a node in either network or an external node as shown. As such it includes a network interface adapter and processing resources such as processors and memories in a manner similar to the other nodes shown in this description.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid-state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method to detect anomalies in observations, the method comprising:
receiving a first plurality of observations regarding operation of a computing system, the observations each having a feature value;
binning the observations based on the respective feature values;
determining a weighting score for the observations based on the binning;
applying the weighting score to a loss function of an autoencoder;
receiving a second plurality of observations;
applying the second plurality of observations as input to the autoencoder to determine a reconstruction error value for each observation of the second plurality of observations; and
detecting a subset of the second plurality of observations as anomalous using the respective reconstruction error values.

2. The method of claim 1, wherein binning comprises placing each observation in a respective bin, each bin having a same interval of feature values and wherein determining the weighting score comprises determining a sum of a number of observations in each bin and normalizing the sums such that observations with feature values in a bin with a higher sum have a lower weight.

3. The method of claim 2, wherein normalizing comprises dividing each sum by a highest one of the sums.

4. The method of claim 1, wherein binning comprises generating bins with different intervals of feature values such that each bin has an equal number of the observations, normalizing the interval of each bin and determining an inverse of the normalized interval of each bin such that observations with feature values in a bin with a smaller interval have a lower weight.

5. The method of claim 4, wherein normalizing comprises dividing each interval by a largest one of the intervals.

6. The method of claim 1, wherein the reconstruction error value for each value is derived from a weighted loss function of the autoencoder, wherein the weighted loss function is a weighted Euclidean distance between an input observation and a reconstructed output of the autoencoder.

7. The method of claim 1, wherein detecting observations as anomalous comprises comparing the reconstruction error value to a threshold.

8. The method of claim 1, wherein the autoencoder comprises an encoder to receive and encode the input observations, a decoder to decode the encoded observations, and a bottleneck between the encoder and the decoder.

9. The method of claim 1, wherein the first plurality of observations is not labeled as normal and anomalous.

10. The method of claim 1, wherein the weighting score comprises a matrix having a score for each bin.

11. The method of claim 1, wherein the weighting score is configured to increase reconstruction error value for observations having incorrect reconstruction in the autoencoder.

12. An apparatus to detect anomalies in observations comprising:
a non-transitory memory comprising executable instructions; and
a processor coupled to the memory and configured to execute the instructions to cause the apparatus to perform operations of:
receiving a first plurality of observations regarding operation of a computing system, the observations each having a feature value;
binning the observations based on the respective feature values;
determining a weighting score for the observations based on the binning;
applying the weighting score to a loss function of an autoencoder;
receiving a second plurality of observations;
applying the second plurality of observations as input to the autoencoder to determine a reconstruction error value for each observation of the second plurality of observations; and
detecting a subset of the second plurality of observations as anomalous using the respective reconstruction error values.

13. The apparatus of claim 12, wherein binning comprises placing each observation in a respective bin, each bin having a same interval of feature values and wherein determining the weighting score comprises determining a sum of a number of observations in each bin and normalizing the sums such that observations with feature values in a bin with a higher sum have a lower weight.

14. The apparatus of claim 12, wherein binning comprises generating bins with different intervals of feature values such that each bin has an equal number of the observations, normalizing the interval of each bin and determining an inverse of the normalized interval of each bin such that observations with feature values in a bin with a smaller interval have a lower weight.

15. The apparatus of claim 12, wherein the reconstruction error value for each value is derived from a weighted loss function of the autoencoder, wherein the weighted loss function is a weighted Euclidean distance between an input observation and a reconstructed output of the autoencoder.

16. The apparatus of claim 12, wherein the weighting score comprises a matrix having a score for each bin.

17. A non-transitory computer readable medium having instructions stored thereon that, when executed by a computer, cause the computer to perform operations comprising:
receiving a first plurality of observations regarding operation of a computing system, the observations each having a feature value;
binning the observations based on the respective feature values;
determining a weighting score for the observations based on the binning;
applying the weighting score to a loss function of an autoencoder;
receiving a second plurality of observations;
applying the second plurality of observations as input to the autoencoder to determine a reconstruction error value for each observation of the second plurality of observations; and
detecting a subset of the second plurality of observations as anomalous using the respective reconstruction error values.

18. The medium of claim 17, wherein binning comprises placing each observation in a respective bin, each bin having a same interval of feature values and wherein determining the weighting score comprises determining a sum of a number of observations in each bin and normalizing the sums such that observations with feature values in a bin with a higher sum have a lower weight.

19. The medium of claim 17, wherein binning comprises generating bins with different intervals of feature values such that each bin has an equal number of the observations, normalizing the interval of each bin and determining an inverse of the normalized interval of each bin such that observations with feature values in a bin with a smaller interval have a lower weight.

20. The medium of claim 17, wherein the reconstruction error value for each value is derived from a weighted loss function of the autoencoder, wherein the weighted loss function is a weighted Euclidean distance between an input observation and a reconstructed output of the autoencoder.
